(19) United States
(12) Patent Application Publication
(10) Pub. No.: US 2010/0282205 A1
(43) Pub. Date: Nov. 11, 2010

(54) INFRARED COMPLEX AND A VEHICLE POWER IMPROVING SYSTEM USING THE INFRARED COMPLEX

(76) Inventors: Chun Yuan CHEN, Taipei City (TW); Young Shuen Chi, Yilan County (TW); Yi Foung Young, Yilan County (TW)

Correspondence Address: Muncy, Geissler, Olds & Lowe, PLLC, 4000 Legato Road, Suite 310, FAIRFAX, VA, 22033, US

(21) Appl. No.: 12/463,804

(22) Filed: May 11, 2009

(51) Int. Cl. F02B 77/04; F02M 35/10

(52) U.S. Cl. 123/198 A; 123/184.61

(57) ABSTRACT

An infrared complex and a vehicle power improving system using the infrared complex are disclosed. The infrared complex is made by an infrared material and a composite material that is coated on the infrared material. The vehicle power improving system comprises at least an element for increasing oxygen content that is fixed in the air intake line of a vehicle engine, at least a first element for reducing oxidized fuel oil and covering the fuel oil intake line of the vehicle engine, at least a second element attached to a shock absorber of the vehicle for restoring deformed shock oil molecules in the shock absorber, and a voltage stabilizer electrically connected with the battery and the generator of the vehicle. Thereby, it is able to increase the oxygen content of the air flowing into the vehicle engine and to reduce the oxidized oil in the fuel oil intake line, so that the utility efficiency of fuel oil can be enhanced and the amount of waste exhaust gas can be reduced.

### TECHNICAL FIELD

The present invention relates to an infrared complex and a system for improving vehicle power and, more particularly, to an infrared complex and a vehicle power improving system that is advantageous in increasing the oxygen content in the air flowing into a vehicle engine, reducing oxidized fuel oil for improving the utility efficiency of fuel oil in the vehicle engine, and decreasing the amount of vehicle exhaust gas. Consequently, not only can the vehicle power be improved, but also the air pollution caused by the vehicle exhaust gas can be reduced.

### BACKGROUND

Typically, a vehicle engine using fuel oil as the power source is provided with an air intake line and a fuel oil intake line for respectively supplying air and fuel oil into the vehicle engine. When the fuel oil is supplied into the engine, it is nebulized and then sprayed by oil nuzzles. At the same time, the ignition system is activated to ignite the sprayed fuel oil to start the explosion and burning. By this way, the engine can perform its normal functions.

According to the foregoing descriptions, the engine power can be influenced by three major factors and these factors are explained in the following.

The first factor is concerned with the oxygen content in the air supplied to a vehicle engine. Generally, the air in the atmosphere is mainly composed of nitrogen and oxygen gases, where nitrogen gas constitutes 78% by volume of the air while oxygen gas constitutes 21% by volume. Other kinds of gases contained in the air, such as argon or carbon dioxide, only constitute small percentages by volume. Therefore, when air is introduced from outside into a vehicle engine via an air intake line, less than one-fourth volume of the air is oxygen that is the gas necessary for combustion. When the fuel oil is ignited to burn, insufficient oxygen content may result in incomplete combustion of the fuel oil. Under this condition, not only will the utility efficiency of fuel oil be decreased and the amount of vehicle exhaust gas (such as carbon monoxide or hydrocarbon compounds) be increased, but also the lifetime of the vehicle engine may be shortened as a result of carbon deposition in the engine.

The second factor is concerned with the problem of fuel oil oxidation. “Oil gum” is produced as a result of the oxidation of fuel oil. This kind of adhesive substance (that is, the oil gum) may damage the structure of vehicle engine and result in incomplete combustion of fuel oil. When the fuel oil is introduced into the vehicle engine via an oil intake line, the oxidized fuel oil cannot be well nebulized before sprayed out because of its adhesive property. Therefore, after the oxidized fuel oil sprayed by oil nuzzles is ignited to burn, it may result in the incomplete combustion of the fuel oil. In this case, in addition to the unnecessary waste of the fuel oil, it may cause air pollution and decrease the lifetime of the vehicle engine as well.

The third factor is concerned with how the ignition system is influenced by the output voltage of vehicle electric power. Generally, the performance of a vehicle engine is principally influenced by ignition system. Specifically, the failure of the vehicle engine may result from weak spark or inaccurate ignition time and may result in decreasing the utility efficiency of fuel oil, evoking engine knocking, or increasing the amount of waste exhaust gas (such as carbon monoxide or hydrocarbon compounds). Since the ignition system utilizes electricity as power source, the stability of the output voltage of the vehicle electric power has direct influence on the performance of the ignition system. In other words, maintaining the stability of voltage is helpful to stabilize the operation of the ignition system.

To solve the problem regarding incomplete combustion, it is known to use infrared material for reactivating fuel oil molecules, which is able to improve the utility efficiency of the fuel oil and then the vehicle engine power. Before the infrared material is to be used, it is necessary to preheat the infrared material in order to have the infrared material emit desired radiation energy. However, the heat produced after a vehicle is getting started is insufficient to have the conventional infrared material emit desired radiation energy. Therefore, an extra heating component is usually necessary for providing sufficient heat energy required to have the infrared material emit desired radiation energy, but the utilization of the extra heating component consumes more energy.

In order to solve above shortcomings, inventor had the motive to study and develop the present invention. After hard research and development, the inventor provides an infrared complex and a vehicle power improving system using the infrared complex for reducing fuel oil consumption, improving the combustion degree of the fuel oil in the vehicle engine, and decreasing the amount of waste exhaust gas. Consequently, not only can the vehicle power be improved, but also the air pollution caused by the vehicle exhaust gas can be effectively reduced.

### SUMMARY OF THE DISCLOSURE

An object of the present invention is to provide an infrared complex and a vehicle power improving system using the infrared complex for increasing the oxygen content in the air flowing into a vehicle engine and reducing the oxidized fuel oil, so that the vehicle power can be improved and the air pollution caused by the vehicle exhaust gas can be reduced.

In order to achieve above object, the present invention provides an infrared complex and a vehicle power improving system using the infrared complex. The infrared complex comprises an infrared material and a composite material, where the composite material is coated on the infrared material. The vehicle power improving system comprises at least an element for increasing oxygen content and at least a first element. The element for increasing oxygen content is fixed in the air intake line of a vehicle engine and used for increasing the oxygen content of the air flowing into the vehicle engine. The first element covers the fuel oil intake line of the vehicle engine and is used for reducing oxidized fuel oil in the fuel oil intake line. Besides, the element for increasing oxygen content and the first element are made by an infrared material and a composite material that is coated on the infrared material.

In practice, the composite material of the infrared complex is preferably made by titanium dioxide, silver, carbon, and graphite.

In practice, the wavelength of infrared radiation ray emitted from the infrared material of the infrared complex is between 25 micrometers to 100 micrometers.

In practice, the vehicle power improving system preferably further comprises at least a second element that is attached to a shock absorber of the vehicle and used for restoring the deformed shock oil molecules in the shock absorber. The second element is made by an infrared material and a composite material that is coated on the infrared material.

In practice, the vehicle power improving system preferably further comprises a voltage stabilizer electrically connected with the battery and the generator of the vehicle for stabilizing the output voltage from the battery and the generator.

The following detailed description, given by way of examples or embodiments, will best be understood in conjunction with the accompanying drawings.

### BRIEF DESCRIPTION OF THE DRAWINGS

FIG. 1 is a schematic view showing elements for increasing oxygen content and a first element in a first embodiment of the vehicle power improving system according to the present invention.

FIG. 2 is a schematic view showing a second element and a voltage stabilizer in the first embodiment of the vehicle power improving system according to the present invention.

FIG. 3 is a partially enlarged view of FIG. 1.

FIG. 4 is a schematic view showing the elements for increasing oxygen content in FIG. 1.

FIG. 5 is an exploded view showing the first element in FIG. 1.

FIG. 6 is a schematic view showing the use of the second element in the first embodiment of the vehicle power improving system according to the present invention.

### DETAILED DESCRIPTION

The present invention discloses an infrared complex and a vehicle power improving system using the infrared complex.

The infrared complex comprises an infrared material and a composite material, where the composite material is coated on the infrared material. The composite material of the infrared complex is made by titanium dioxide, silver, carbon, and graphite. The wavelength of infrared radiation ray emitted from the infrared material of the infrared complex is between 25 micrometers to 100 micrometers.

The vehicle power improving system comprises at least an element for increasing oxygen content and at least a first element, which are made by an infrared material and a composite material that is coated on the infrared material. The element for increasing oxygen content is fixed in the air intake line of a vehicle engine and used for increasing the oxygen content in the air flowing into the vehicle engine. The first element covers the fuel oil intake line of the vehicle engine and is used for reducing the oxidized fuel oil in the fuel oil intake line.

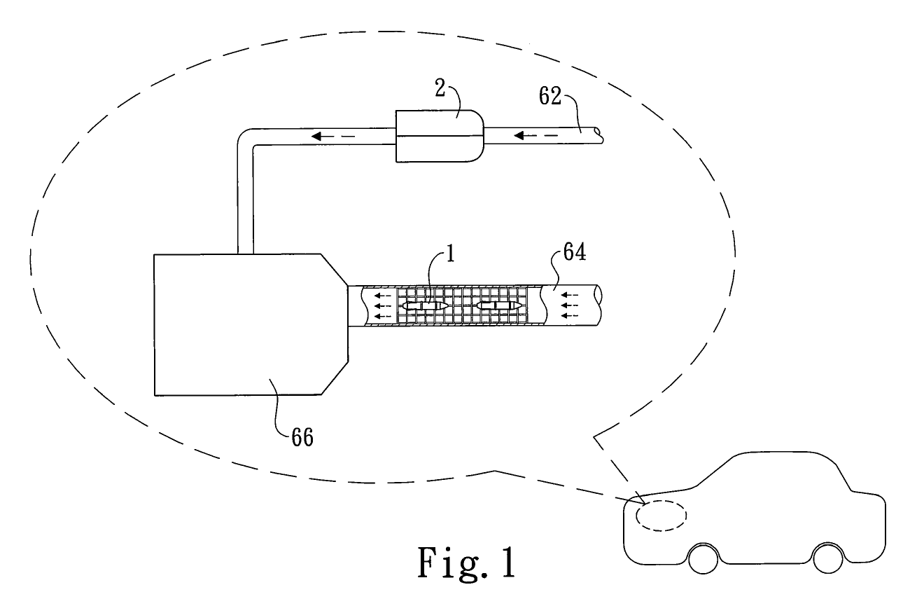

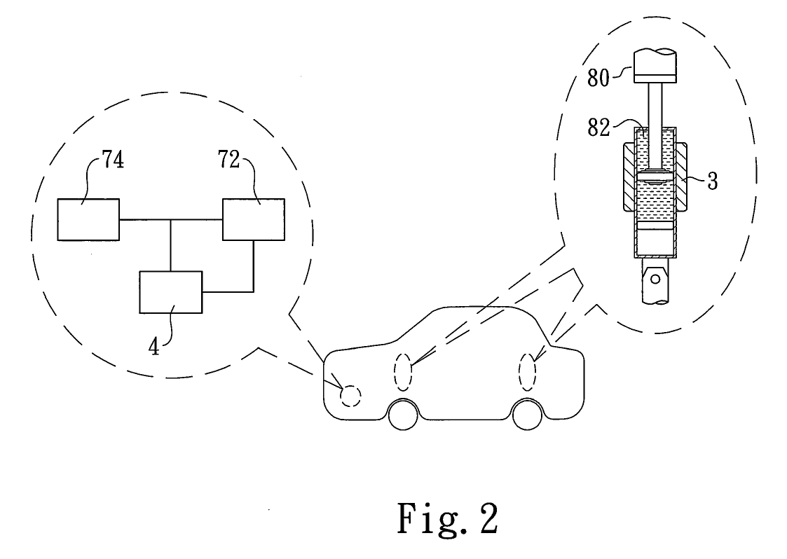

Please refer to FIGS. 1 and 2 showing a first embodiment of the vehicle power improving system according to the present invention. In this embodiment, the vehicle power improving system comprises four elements for increasing oxygen content 1 (where only two elements 1 are shown in FIG. 1), plural first elements 2 (where only one first element 2 is shown in FIG. 1), plural second elements 3 (where only one second element 3 is shown in FIG. 2), and a voltage stabilizer 4.

The element for increasing oxygen content 1 and the first and second elements 2, 3 are all made by an infrared material and a composite material that is coated on the infrared material. In practice, the composite material is made by titanium dioxide, silver, carbon, and graphite. The wavelength of infrared radiation rays emitted from the infrared material is between 25 micrometers to 100 micrometers

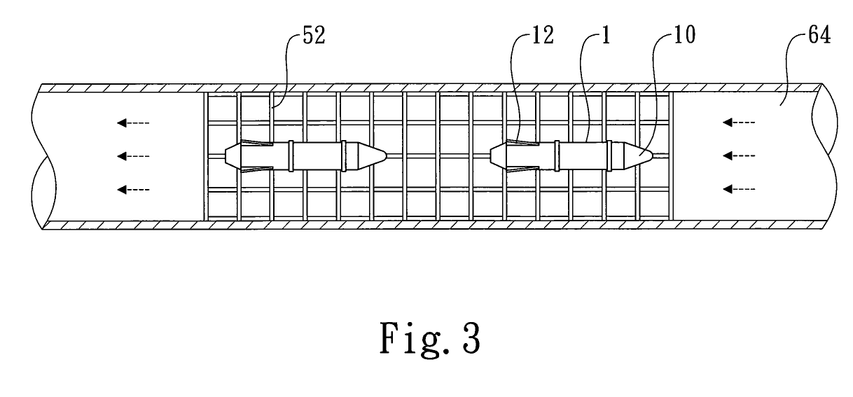

The element for increasing oxygen content 1 is fixed in the air intake line 64 of a vehicle engine. The emitted radiation rays can resonate and amplify the component molecules of the air flowing into the vehicle engine. By this way, the oxygen content in the intake air can be increased and the combustion degree of fuel oil can be raised accordingly. In practice, the element for increasing oxygen content 1 is in shuttle shape and has a head 10 and a base 12. The element for increasing oxygen content 1 tapers at the head 10 and enlarges gradually at the base 12. The infrared radiation rays emitted from the element for increasing oxygen content 1 are electromagnetic waves that travel in a straight path. Because the element for increasing oxygen content 1 is in shuttle shape, the infrared radiation rays can be reflected in various directions within the air intake line 64. Besides, when the element for increasing oxygen content 1 is placed in the air intake line 64, the head 10 is placed toward the direction in which the air flows in the air intake line 64 (as shown by the arrow in FIG. 3). Although the element for increasing oxygen content 1 occupies certain space in the air intake line 64, its shuttle shape can minimize the influence on the total amount of intake air.

In order to verify the capacity of the element for increasing oxygen content, the following experiment is conducted. Put the element for increasing oxygen content according to the present invention into an open-ended tube and then pump air into the tube from an opening at one end thereof. An experimental group and a control group are included in this experiment. In the experimental group, the temperature of the air pumped into the tube is between 32 to 35° C. higher than room temperature. In the control group, the temperature of the air pumped into the tube is approximately equal to room temperature, that is, the temperature between 25 to 26° C. The results obtained from the control group reveal that the element for increasing oxygen content fails to any emit infrared radiation ray and the oxygen content of the air leaving the tube constitutes about 20.9% by volume. In other words, the proportion of the oxygen in the air leaving the tube is roughly the same of that in the air flowing into the tube. As to the experimental group, however, 30 to 40 seconds after the experiment is conducted, the results obtained from the experimental group reveal that the oxygen content of the air leaving the tube constitutes about 25% by volume. Based on above results, the oxygen content of the air leaving the tube in the experimental group significantly increases by 20% when compared with the control group. After a vehicle is getting started, the temperature of the vehicle is generally equal to the temperature set in the experimental group, that is, the temperature between 32 to 35° C. Therefore, the heat produced after the vehicle is getting started is sufficient to have the element for increasing oxygen content emit desired infrared radiation rays. In other words, the element for increasing oxygen content can be activated without using any extra heating component and the oxygen content of the air flowing into the vehicle engine can be thus effectively increased.

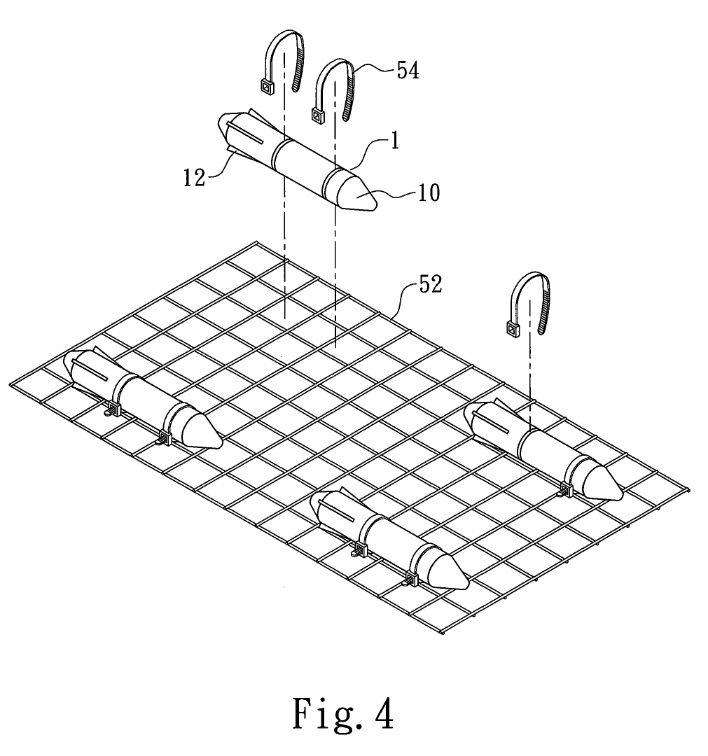

Please refer to FIGS. 3 and 4. In practice, as shown in these figures, a net structure 52 and a plurality of fixing pieces 54 are used to position the element for increasing oxygen content 1 in the air intake line 64. In this embodiment, each fixing piece 54 is a fixing strip having two ends that are connectable with each other and is used for positioning each element for increasing oxygen content 1 on the net structure 52. After locating the elements for increasing oxygen content 1 on the net structure 52, roll up the net structure 52 and place it into the air intake line 64 of the vehicle engine.

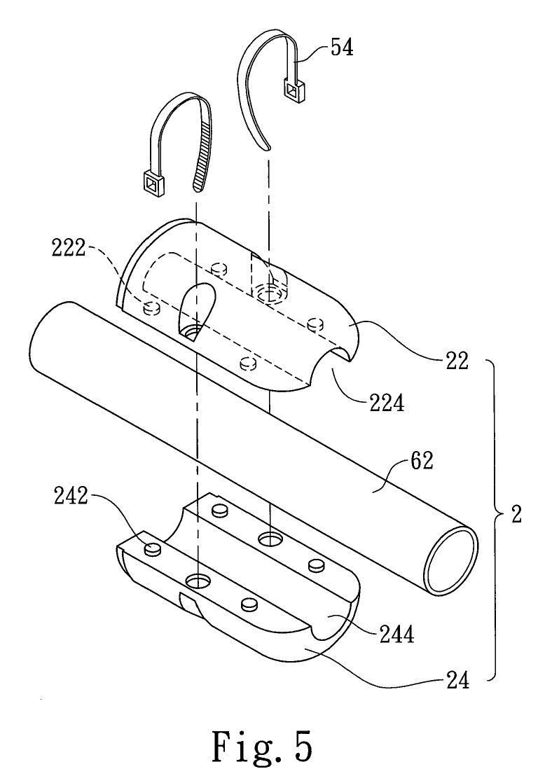

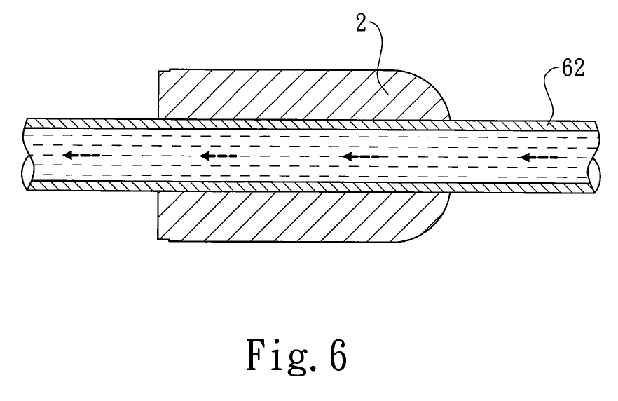

As shown in FIGS. 5 and 6, the first element 2 is positioned to cover the fuel oil intake line 62. In this embodiment, the first element 2 has a first half body 22 and a second half body 24. The first and the second half bodies 22, 24 are provided respectively with corresponding grooves 224, 244 for covering the fuel oil intake line 62. Besides, the first half body 22 is provided with a first connecting part 222 while the second half body 24 is provided with a second connecting part 242. As shown in the figures, the first connecting part 222 is a recessed part while the second connecting part 242 is a protruded part corresponding to the recessed part. Therefore, the first element 2 can be positioned to cover the fuel oil intake line 62 after the first and second connecting parts are engaged with each other. Moreover, as shown in FIG. 5, each of the first and second half bodies 22, 24 also can be provided with two through holes that are used for being inserted with two fixing pieces 54 in order to connect the first and second half bodies 22, 24 more firmly.

The results obtained from experimental test for the first element 2 reveal that the infrared-radiation-effect diameter of the first element 2 is about 35 millimeters and the radiation rays can penetrate the fuel oil intake line 62 and change the molecular structure of the inside fuel oil. After a vehicle is started, the produced heat is sufficient to have the first element 2 emit desired infrared radiation rays for reducing the oxidized fuel oil via molecular resonance. In this way, the gum in the fuel oil can be eliminated and the fuel oil can be well and evenly sprayed by the oil nozzles. Therefore, incomplete combustion of the fuel oil can be prevented and the amount of vehicle exhaust gas (such as carbon monoxide or hydrocarbon compounds) can be effectively reduced.

Each second element 3 is attached to a shock absorber and is used for restoring the deformed shock oil molecules in the shock absorber. As shown in FIG. 2, the second element 4 is designed in strip form and is attached on part of the shock absorber 80 containing shock oil 82. When the shock absorber 80 continues to work, the shock oil 82 inside the shock absorber 80 may be deformed since the shock oil 82 is continuously compressed by the piston of the shock absorber 80. Under this condition, the infrared radiation rays emitted from the second element 3 can restore the configuration of the fuel oil molecules. Moreover, as shown in FIG. 2, the voltage stabilizer 4 is electrically connected with a vehicle battery 72 and a vehicle generator 74 for stabilizing the output voltage from the vehicle battery 72 and the vehicle generator 74.

Therefore, the present invention has following advantages.

1. The infrared complex according to the present invention can be activated to emit desired infrared radiation energy when provided with the heat produced after a vehicle is getting started.

2. By providing the element for increasing oxygen content according to the present invention, the oxygen content of the air flowing into the vehicle engine can be increased and consequently the combustion degree of the fuel oil can be improved.

3. By providing the first element according to the present invention, the oxidized fuel oil in the fuel oil intake line of the vehicle engine can be reduced, that is, the adhesive material (gum) in the fuel oil produced during the oxidization of the fuel oil can be eliminated. Accordingly, the fuel oil can be well and evenly sprayed by the oil nuzzles and the combustion degree of the fuel oil can be improved.

4. By providing the second element according to the present invention, the deformed shock oil in a shock absorber can be restored, so that the performance of the shock oil can be maintained and the lifetime thereof can be lengthened.

5. By providing the voltage stabilizer according to the present invention, the output voltage of the vehicle electric power can be stabilized. Consequently, the influence caused by unstable voltage on the ignition system can be minimized to maintain the normal performance of the vehicle engine.

As disclosed in the above description and attached drawings, the present invention can provide an infrared complex and a vehicle power improving system that are helpful to increase the oxygen content in the air flowing into a vehicle engine and to reduce the oxidized fuel oil, so that the utility efficiency of fuel oil in the vehicle engine is improved and the amount of vehicle exhaust gas is decreased. Consequently, not only can the vehicle power be improved, but also the air pollution caused by the vehicle waste exhaust gas can be reduced for the purpose of energy saving and carbon reducing. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An infrared complex, used for improving vehicle power, comprising an infrared material and a composite material, where the composite material is coated on the infrared material.

2. The infrared complex as claimed in claim 1, wherein the composite material is made by titanium dioxide, silver, carbon, and graphite.

3. The infrared complex as claimed in claim 1, wherein the wavelength of infrared radiation rays emitted from the infrared material is between 25 micrometers to 100 micrometers.

4. A vehicle power improving system, comprising:
at least an element for increasing oxygen content, fixed in the air intake line of a vehicle engine;
at least a first element, covering the fuel oil intake line of the vehicle engine and used for reducing the oxidized fuel oil in the fuel oil intake line;
wherein, the at least one element for increasing oxygen-content and the at least one first element are made by an infrared material and a composite material that is coated on the infrared material.

5. The vehicle power improving system as claimed in claim 4, wherein the element for increasing oxygen content is in shuttle shape.

6. The vehicle power improving system as claimed in claim 4, wherein the first element includes a first half body and a second half body and the first and the second half bodies are provided respectively with a first and a second connecting parts, so that the first half body is connected with the second half body by means of the connection between the first and the second connecting parts to cover the fuel oil intake line.

7. The vehicle power improving system as claimed in claim 4, wherein the composite material is made by titanium dioxide, silver, carbon, and graphite.

8. The vehicle power improving system as claimed in claim 4, wherein the wavelength of infrared radiation rays emitted from the infrared material is between 25 micrometers to 100 micrometers.

9. The vehicle power improving system as claimed in claim 4, further comprising at least a second element for restoring deformed shock oil molecules in a shock absorber, wherein each second element is attached to a shock absorber of the vehicle and is made by an infrared material and a composite material that is coated on the infrared material.

10. The vehicle power improving system as claimed in claim 9, wherein the composite material is made by titanium dioxide, silver, carbon, and graphite.

11. The vehicle power improving system as claimed in claim 9, wherein the wavelength of infrared radiation rays emitted from the infrared material is between 25 micrometers to 100 micrometers.

12. The vehicle power improving system as claimed in claim 9, further comprising a voltage stabilizer electrically connected with vehicle battery and vehicle generator for stabilizing the output voltage of the vehicle battery and the vehicle generator.
